(19) United States
(12) Patent Application Publication
(10) Pub. No.: US 2026/0012065 A1
(43) Pub. Date: Jan. 8, 2026

(54) STEPPER MOTOR

(71) Applicant: AAC Microtech (Changzhou) Co., Ltd., Changzhou City (CN)

(72) Inventor: Lubin Mao, Changzhou (CN)

(21) Appl. No.: 19/001,349

(22) Filed: Dec. 24, 2024

Related U.S. Application Data
(63) Continuation of application No. PCT/CN2024/103053, filed on Jul. 2, 2024.

(51) Int. Cl. H02K 37/00; H02K 1/14; H02K 7/08; H02K 11/00

(52) U.S. Cl. CPC H02K 37/00; H02K 1/145; H02K 7/083; H02K 11/0094; H02K 2211/03

(57) ABSTRACT

The present disclosure relates to a stepper motor. The stepper motor according to embodiments of the present disclosure includes: a rotor assembly including a rotatory shaft and a plurality of magnetic steel units sequentially assembled along circumference of the rotatory shaft, inner walls of the plurality of magnetic steel units are in contact with an outer wall of the rotatory shaft, and the plurality of magnetic steel units are assembled to form a magnetic steel; at least one stator assembly sleeved on the rotor assembly; and two support assemblies each include a respective bearing sleeved on the rotatory shaft. The rotatory shaft includes a main body connected to the magnetic steel and two end portions, respective bearings are sleeved on the two end portions respectively, and a diameter of the main body is smaller than diameters of the two end portions.

### CROSS REFERENCE TO RELATED APPLICATIONS

The present application is a continuation of PCT Patent Application No. PCT/CN2024/103053, filed Jul. 2, 2024, which is incorporated by reference herein in its entirety.

### TECHNICAL FIELD

The present disclosure relates to the field of motor technology, and in particular to a stepper motor.

### BACKGROUND

The sizes of the stepper motors are becoming increasingly smaller, with the sizes of the shafts being also reducing. In related technologies, a magnetic steel and a shaft is usually fixed to each other by inserting the shaft into the magnetic steel and applying adhesive in the gap between the shaft and the magnetic steel to fix the shaft to magnetic steel. The above fixing method leads to a decrease in the structural strength of the shaft in the condition that the size of the shaft is further reduced.

### SUMMARY

The present disclosure aims to provide a stepper motor to address the above-mentioned technical problem of reduced structural strength of the shafts.

The technical solution of the present disclosure is as follows. Embodiments of the present disclosure provide a stepper motor including: a rotor assembly including a rotatory shaft and a plurality of magnetic steel units sequentially assembled along circumference of the rotatory shaft, where inner walls of the plurality of magnetic steel units are in contact with an outer wall of the rotatory shaft, and the plurality of magnetic steel units are assembled to form a magnetic steel; at least one stator assembly sleeved on the rotor assembly, where each stator assembly of the at least one stator assembly includes a respective fixed claw pole arranged around circumference of the magnetic steel and respective coils sleeved on the respective fixed claw pole; and two support assemblies respectively arranged at both ends of the rotor assembly, where each support assembly of the two support assemblies includes a respective bearing sleeved on the rotatory shaft. The rotatory shaft includes a main body connected to the magnetic steel and two end portions respectively located at both ends of the main body, respective bearings are sleeved on the two end portions respectively, and a diameter of the main body is smaller than diameters of the two end portions.

As an improvement, the respective bearing is a ball bearing or a sliding bearing.

As an improvement, each support assembly of the two support assemblies further includes a respective end cap connected to the rotatory shaft via the respective bearing, and the rotatory shaft is rotatable relative to the respective end cap.

As an improvement, gaskets are provided respectively at a top and a bottom of the magnetic steel, the gaskets are respectively sleeved on the two end portions, and a diameter of an outer periphery of a respective gasket of the gaskets is equal to a diameter of an outer periphery of the magnetic steel.

As an improvement, the respective bearing includes an inner ring connected to a corresponding end portion, an outer ring arranged to enclose an outer surface of the inner ring, and balls arranged between the inner ring and the outer ring, and where a first ball guide groove configured to cooperate with the balls is defined on the outer surface of the inner ring, a second ball guide groove configured to cooperate with the balls is defined on an inner surface of the outer ring, and the first ball guide groove and the second ball guide groove form an accommodating chamber for accommodating the balls.

As an improvement, each stator assembly of the at least one stator assembly further includes a respective housing sleeved on the respective coils; and the respective housing includes a plurality of housing walls sequentially connected to each other around circumference of the respective coils, the plurality of housing walls includes two first housing walls, outer walls of the first housing walls are planar and hollow portions for receiving the respective coils are formed on the first housing walls, portions of the respective coils are respectively received in the hollow portions, and the two first housing walls are arranged to face each other.

As an improvement, first planes parallel to the outer walls of the first housing walls are formed on the portions of the respective coils received in the hollow portions.

As an improvement, the respective housing includes four housing walls sequentially connected to each other around the circumference of the respective coils and further includes a second housing wall and a third housing wall arranged to face each other, and each of the second housing wall and the third housing wall has a respective curved outer wall; the third housing wall includes a plurality of wall sections sequentially connected to each other around the circumference of the respective coils, and each wall section of the plurality of wall sections has a respective planar outer wall; and the stepper motor further includes a circuit broad fixed to the third housing wall, and the circuit broad includes a plurality of circuit broad units respectively fixed to the plurality of wall sections.

As an improvement, the stepper motor includes a plurality of stator assemblies and a plurality of housings respectively sleeved on the plurality of stator assemblies, where the plurality of stator assemblies are stacked along an axial direction of the rotor assembly, and the plurality of housings are also stacked along the axial direction of the rotor assembly.

As an improvement, the respective fixed claw pole includes a first claw pole portion and a second claw pole portion arranged to face and cooperate with each other; the first claw pole portion includes a first base sleeved on the rotatory shaft and first pole claws bending and extending, along an axial direction of the rotatory shaft, from an edge of the first base towards the second claw pole portion, and the first pole claws are arranged at intervals along circumference of the first base; the second claw pole portion includes a second base sleeved on the rotatory shaft and second pole claws bending and extending, along the axial direction of the rotatory shaft, from an edge of the second base towards the first base, and the second pole claws are arranged at intervals along circumference of the second base; and the first pole claws are arranged to interleave with the second pole claws, each first pole claw of the first pole claws is located between two respective adjacent second pole claws of the second pole claws, the first pole claws and the second pole claws form a pole claw ring, and the respective coils are sleeved on circumference of the pole claw ring.

### BRIEF DESCRIPTION OF DRAWINGS

FIG. 1 is a perspective view of the stepper motor according to some embodiments of the present disclosure.

FIG. 2 is a side view the stepper motor shown in FIG. 1.

FIG. 3 is a cross-sectional view of the stepper motor shown in FIG. 2 taken along the A-A direction.

FIG. 4 is a cross-sectional view of the stepper motor shown in FIG. 2 taken along the B-B direction.

FIG. 5 is an exploded view of the structure of the stepper motor shown in FIG. 1.

FIG. 6 is an exploded view of the structure of the rotor assembly of the stepper motor shown in FIG. 1.

FIG. 7 is an exploded view of the structure of a bearing of the stepper motor shown in FIG. 1.

FIG. 8 is a schematic diagram of the structure of the stator assembly of the stepper motor shown in FIG. 1.

FIG. 9 shows the cooperation of the housing with the coils in the stepper motor shown in FIG. 1.

FIG. 10 is a schematic diagram of the structure of the fixed claw pole of the stepper motor shown in FIG. 1.

FIG. 11 is a perspective view of the stepper motor according to some embodiments of the present disclosure.

FIG. 12 is a cross-sectional view of the stepper motor shown in FIG. 11.

FIG. 13 is an exploded view of the structure of the stepper motor shown in FIG. 11.

In the drawings, the reference numerals denote:

10—rotor assembly; 101—rotatory shaft; 1011—main body; 1012—end portion; 102—magnetic steel; 1021—magnetic steel unit; 1021a—inner wall; 1021b sidewall; 102a—first magnetic pole; 102b—second magnetic pole; 103—gasket; 20—stator assembly; 201—housing; 2011—first housing wall; 211—hollow portion; 2012—second housing wall; 2013—third housing wall; 2013a—wall section; 202 coil; 2021—first plane; 20a—fixed claw pole; 203—first claw pole portion; 2031 first base; 2032—first pole claw; 204—second claw pole portion; 2041—second base; 2042—second pole claw; 20b—pole claw ring; 30—circuit board; 301—circuit board unit; 40—support assembly; 401—end cap; 402—bearing; 4021—inner ring; 4022—outer ring; 4023—balls; 4024—first ball guide groove; 4025—second ball guide groove.

### DETAILED DESCRIPTION OF EMBODIMENTS

The present disclosure will be illustrated in conjunction with the accompanying drawings and the embodiments.

It is noted that the terms “first,” “second,” “third”, and the like used in the description, claims, and accompanying drawings of the present disclosure are intended to distinguish different objects, rather than to describe a specific order. In addition, the term “including” and any variations thereof are intended to express non-exclusive inclusions. For example, a process, method, system, product, or device that includes a series of operations or units is not limited to the listed operations or units, but may optionally include operations or units that are not listed, or may optionally include other operations or units that are inherent to these processes, methods, products, or devices.

In the embodiments of the present disclosure, all directional indications (such as up, down, left, right, front, back, inside, outside, top, bottom, etc.) are only used to explain the relative positional relationships among the components in a specific posture (as shown in the accompanying drawings). When the specific posture changes, the directional indication will change accordingly. When a component is referred to as “fixed to” or “arranged on” another component, the component may be directly on another component or there may be an intermediate component. When a component is referred to as “connected to” another component, it may be directly connected to another component or there may be an intermediate component.

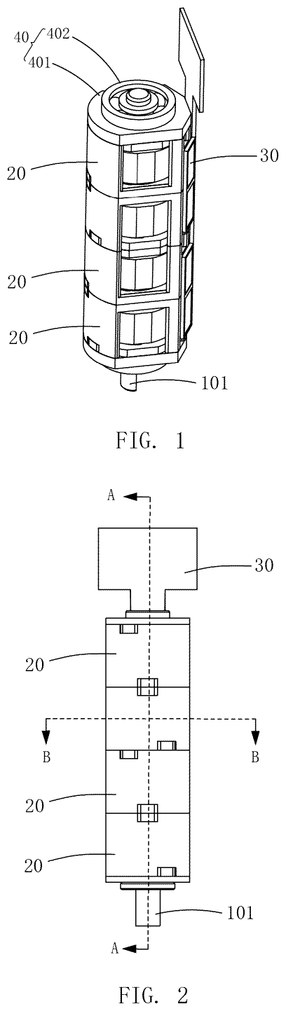

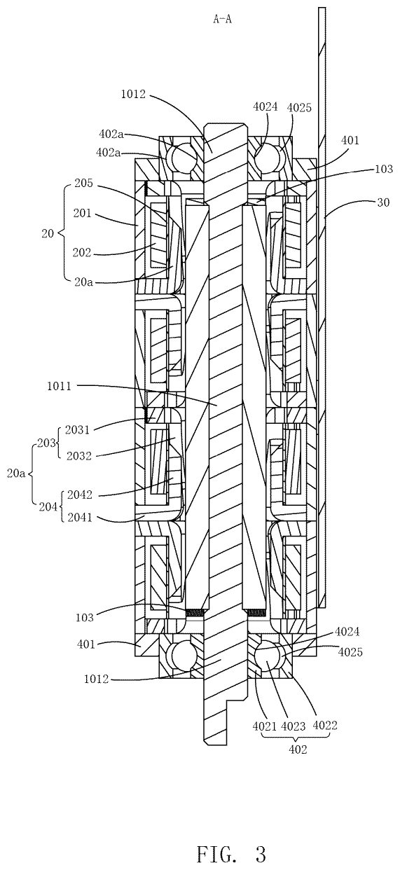

Embodiments of the present disclosure provide a stepper motor, referring to FIGS. 1 to 5, the stepper motor includes a rotor assembly 10, at least one stator assembly 20, a circuit board 30, and two support assemblies 40.

Referring to FIGS. 3 to 5, the rotor assembly 10 includes a rotatory shaft 101 and a magnetic steel 102 sleeved on the rotatory shaft 101, and the magnetic steel 102 is rotatable together with the rotatory shaft 101.

Referring to FIGS. 3 to 6, the magnetic steel 102 includes a plurality of magnetic steel units 1021 sequentially assembled along circumference of the rotatory shaft 101, and inner walls 1021a of the plurality of magnetic steel units 1021 are in contact with an outer wall 101a of the rotatory shaft 101. The plurality of magnetic steel units 1021 are assembled to form the magnetic steel 102, and sidewalls 1021b of two adjacent magnetic steel units 1021 are in contact with each other.

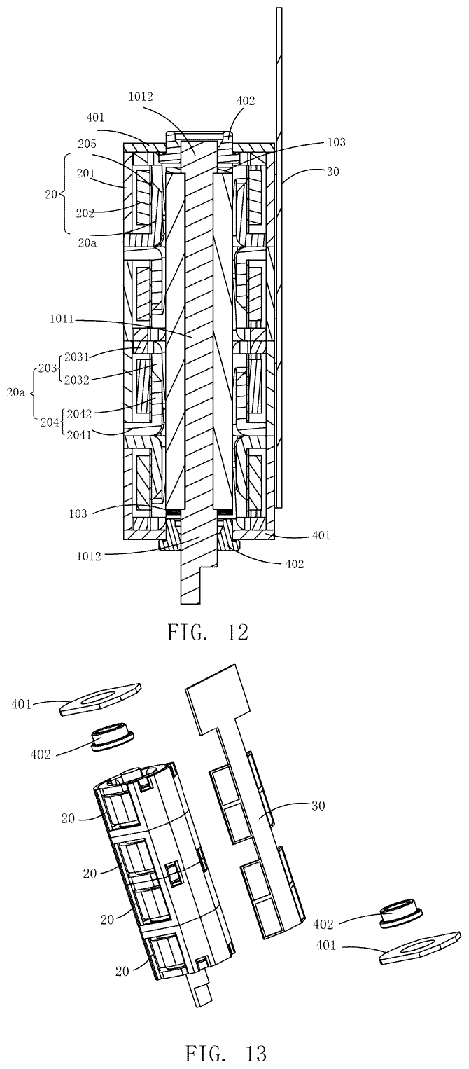

In FIGS. 1, 3, 5, and 11 to 13, a stepper motor including a plurality of stator assemblies 20 is taken as an example. The plurality of stator assemblies 20 are stacked along an axial direction of the rotor assembly 10, and the plurality of stator assemblies 20 are arranged at intervals and are sleeved on the rotor assembly 10. In some embodiments, the plurality of stator assemblies 20 are arranged at intervals and are sleeved on the magnetic steel 102, and each stator assembly 20 includes a respective housing 201, respective coils 202, and a respective fixed claw pole 20a. The respective fixed claw pole 20a is arranged around circumference of the rotor assembly 10, the respective coils 202 are sleeved and fixed on the respective fixed claw pole 20a, and the respective housing 201 is sleeved on the respective coils 202.

Two support assemblies 40 are provided, and the two support assemblies 40 are respectively arranged at both ends of the rotor assembly 10. Each support assembly 40 includes a respective end cap 401 and a respective bearing 402. The respective end cap 401 is connected to the rotatory shaft 101 via the respective bearing 402. The respective bearing 402 is sleeved on the rotatory shaft 101. The respective end cap 401 is sleeved on the circumference of the respective bearing 402, and the rotatory shaft 101 is rotatable relative to the respective end cap 401.

Referring to FIGS. 3, 5, and 6, the rotatory shaft 101 includes a main body 1011 connected to the magnetic steel 102 and two end portions 1012 respectively located at both ends of the main body 1011. The respective bearings 402 are sleeved on the two end portions 1012 respectively, and a diameter D1 of the main body 1011 is smaller than diameters D2 of the two end portions 1012.

In the embodiments, by assembling the plurality of magnetic steel units sequentially along circumference of the rotatory shaft and allowing the inner walls of the plurality of magnetic steel units to be in contact with the outer wall of the rotatory shaft, the structural strength of the rotatory shaft can be increased. Moreover, the rotatory shaft includes the main body connected to the magnetic steel and two end portions respectively cooperating with the respective bearings, and the diameters of the two end portions are larger than the diameter of the main body, in this way, the structural strength of the rotatory shaft can be further increased.

In some embodiments, referring to FIGS. 11 to 13, the respective bearing 402 may be a sliding bearing.

In some embodiments, referring to FIGS. 1, 3, and 5, the respective bearing 402 may be a ball bearing. Using relatively small ball bearings to support the rotatory shaft is conducive to reduce of the friction loss of the rotatory shaft.

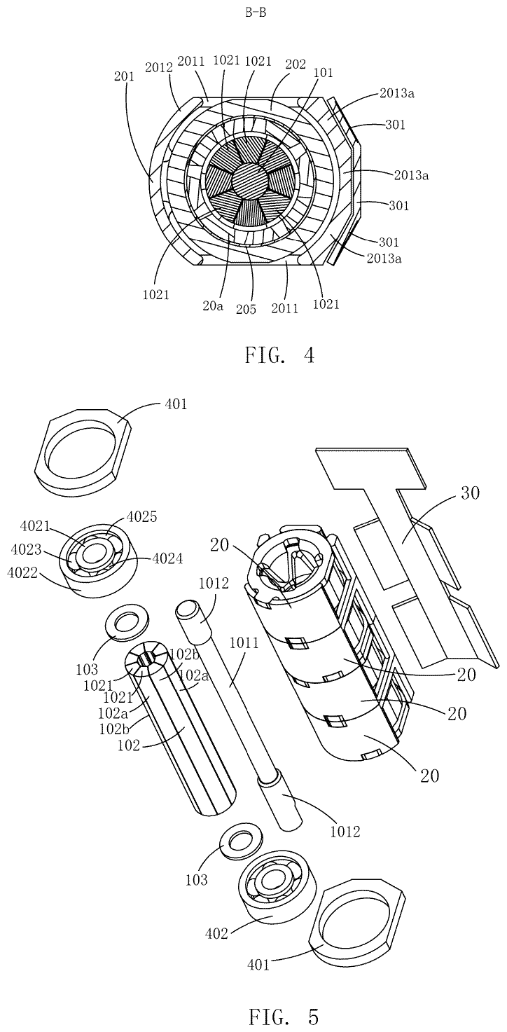

In some embodiments, referring to FIGS. 3 and 5, gaskets 103 are provided respectively at a top and a bottom of the magnetic steel 102. The gaskets 103 are annular and are respectively sleeved on the two end portions 1012 of the rotatory shaft 101. The gaskets 103 are arranged between the magnetic steel 102 and the respective bearings 402, and a diameter of an outer periphery of a respective gasket of the gaskets 103 is equal to a diameter of an outer periphery of the magnetic steel 102. The size of the outer periphery of each gasket matches with the size of the outer periphery of the magnetic steel, in this way, the bonding strength of the gaskets with the magnetic steel can be increased.

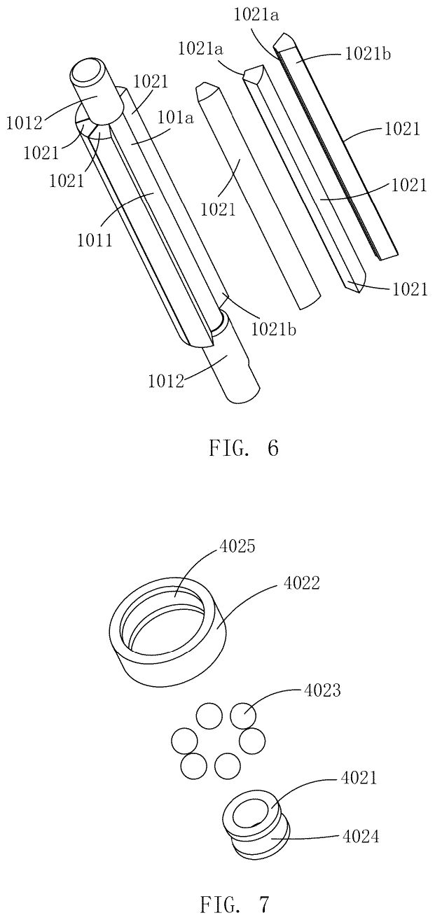

In some embodiments, referring to FIGS. 5 and 7, the respective bearing 402 is a ball bearing and includes an inner ring 4021 connected to a corresponding end portion 1012, an outer ring 4022 arranged to enclose an outer surface of the inner ring 4021, and balls 4023 arranged between the inner ring 4021 and the outer ring 4022. A first ball guide groove 4024 configured to cooperate with the balls 4023 is defined on the outer surface of the inner ring 4021, a second ball guide groove 4025 configured to cooperate with the balls 4023 is defined on an inner surface of the outer ring 4022, and the first ball guide groove 4024 and the second ball guide groove 4025 form an accommodating chamber for accommodating the balls 4023, such that some balls 4023 roll in the accommodating chamber. The longitudinal sections of the first ball guide groove 4024 and the second ball guide groove 4025 are respectively the arcuate portions 402a having shapes matched with the contours of the balls 4023. In some embodiments, the inner ring 4021 rotates with the rotation of the rotatory shaft 101, and there is no relative rotation between the rotatory shaft 101 and the inner ring 4021, which is conducive to reducing the friction loss of the rotatory shaft.

In some embodiments, referring to FIGS. 4, 8 and 9, the respective housing 201 includes a plurality of housing walls sequentially connected to each other around circumference of the respective coils 202, the plurality of housing walls includes two first housing walls 2011, outer walls of the first housing walls 2011 are planar and hollow portions 211 for receiving the respective coils 202 are formed on the first housing walls 2011, portions of the respective coils 202 are respectively received in the hollow portions 211, and the two first housing walls 2011 are arranged to face each other. Two of the plurality of housing walls are configured as the first housing walls having the hollow portions for receiving the respective coils, and portions of the respective coils are respectively received in the hollow portions. In this way, the size of the stepper motor in the direction S1 perpendicular to the outer walls of the first housing walls can do not include the thicknesses of the two first housing walls, thereby reducing the size of the stepper motor in the direction S1 perpendicular to the outer walls of the first housing walls, which is conducive to achieving miniaturization of the stepper motor. Moreover, due to the planar outer walls of the first housing walls 2011, when assembling the stepper motor, the planar outer walls can facilitate fitting with other components, which is conducive to reducing the difficulty of assembling the stepper motor.

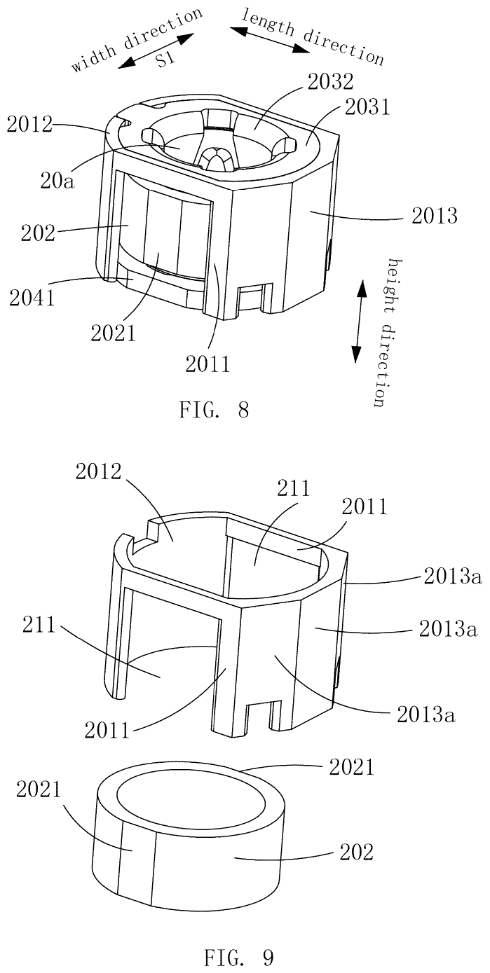

In some embodiments, referring to FIGS. 8 and 9, first planes 2021 parallel to the outer walls of the first housing walls 2011 are formed on the portions of the respective coils 202 received in the hollow portions 211. The first planes 2021 are formed on the outer walls of the respective coils 202. By machining the outer walls of the portions of the respective coils received in the hollow portions into planar outer walls, compared with the arcuate outer walls without machining, the size of the stepper motor in the direction S1 perpendicular to the outer walls of the first housing walls can be further reduced, which is conducive to achieving miniaturization of the stepper motor. Alternatively, the saved space can be used to increase the number of turns of the coils, increase the thickness of the claw poles, or increase the size of the magnetic steel, in order to further improve torque performance.

In some embodiments, referring to FIGS. 8 and 9, the respective housing 201 includes four housing walls sequentially connected to each other around the circumference of the respective coils 202 and further includes a second housing wall 2012 and a third housing wall 2013 arranged to face each other, and each of the second housing wall 2012 and the third housing wall 2013 has a respective curved outer wall. The cross-section of the outer wall of the second housing wall 2012 is curved far away from the rotatory shaft 101. The provided second housing wall having a curved outer wall is suitable for application scenarios that require arcuate surfaces for fitting.

In some embodiments, referring to FIGS. 4 and 9, the third housing wall 2013 includes a plurality of wall sections 2013a sequentially connected to each other around the circumference of the respective coils 202, and each wall section of the plurality of wall sections 2013a has a respective planar outer wall. The circuit broad 30 is fixed to the third housing wall 2013, and the circuit broad 30 includes a plurality of circuit broad units 301 respectively fixed to the plurality of wall sections 2013a. For example, the number of the wall sections 2013a may be three.

In this way, it is easier for each circuit broad unit of the circuit broad to fit with the corresponding wall section having a planar outer wall, and the circuit board can be fixed without providing pins, which is conducive to further miniaturization of the stepper motor. Exemplarily, the outgoing lines of the coils may be spot welded to the circuit board using leads, and the outgoing lines of the circuit board may be remained without being cut off on the third housing wall to improve the structural strength of the stepper motor.

In some embodiments, referring to FIGS. 7 to 9, the respective fixed claw pole 20a includes a first claw pole portion 203 and a second claw pole portion 204 arranged to face and cooperate with each other. The first claw pole portion 203 includes a first base 2031 sleeved on the rotatory shaft 101 and first pole claws 2032 bending and extending, along an axial direction of the rotatory shaft 101, from an edge of the first base 2031 towards the second claw pole portion 204, and the first pole claws 2032 are arranged at intervals along circumference of the first base 2031. The second claw pole portion 204 includes a second base 2041 sleeved on the rotatory shaft 101 and second pole claws 2042 bending and extending, along the axial direction of the rotatory shaft 101, from an edge of the second base 2041 towards the first base 2031, and the second pole claws 2042 are arranged at intervals along circumference of the second base 2041. The first pole claws 2032 are arranged to interleave with the second pole claws 2042, each first pole claw of the first pole claws 2032 is located between two respective adjacent second pole claws of the second pole claws 2042, the first pole claws 2032 and the second pole claws 2042 form a pole claw ring 20b, and the respective coils 202 are sleeved on circumference of the pole claw ring 20b.

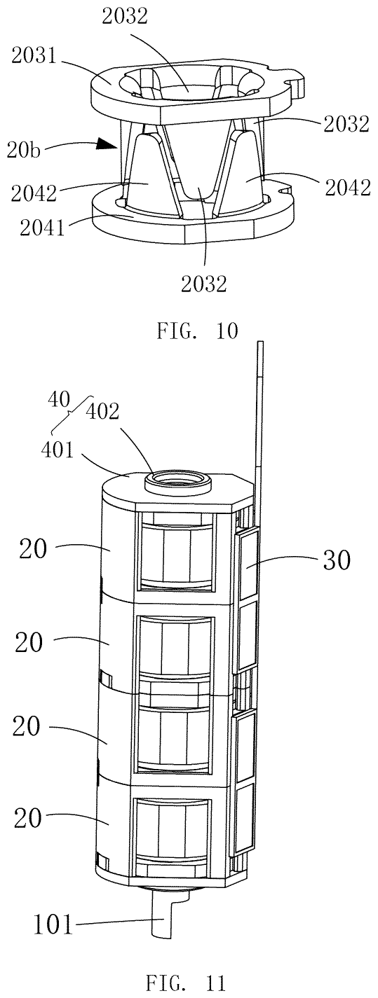

In some embodiments, referring to FIGS. 3 and 10, a plurality of first pole claws 2032 are evenly distributed on the inner periphery of the first base 2031, and there is spacing between every two adjacent first pole claws 2032. A plurality of second pole claws 2042 are evenly distributed on the inner periphery of the second base 2041, and there is spacing between every two adjacent second pole claws 2042. When the respective coils 202 are sleeved on circumference of the pole claw ring 20b, the respective coils 202 are located between the first base 2031 and the second base 2041. When the respective housing 201 is sleeved on the respective coils 202, the outer periphery of the first base 2031 and the outer periphery of the second base 2041 are in contact with an inner wall of the respective housing 201

In some embodiments, referring to FIG. 5, a plurality of first magnetic poles 102a and a plurality of second magnetic poles 102b arranged alternately along the circumference of the magnetic steel 102 are formed on the outer surface of the magnetic steel 102. The outer wall of one of two respective adjacent magnetic steel units 1021 is configured as a first magnetic pole 102a, and the outer wall of the other one is configured as a second magnetic pole 102b. One respective first magnetic pole 102a and one respective second magnetic pole 102b have opposite magnetism, for example, one is configured as N pole and the other is configured as S pole.

In some embodiments, referring to FIG. 10, when cooperating with each other, the plurality of first pole claws 2032 of the first claw pole portion 203 interleave with the plurality of second pole claws 2042 of the second claw pole portion 204, in other words, each second pole claw 2042 is located at the spacing between two corresponding adjacent first pole claws 2032, the plurality of first pole claws 2032 are configured to be in correspondence to the plurality of first magnetic poles 102a of the magnetic steel, and the plurality of second pole claws 2042 are configured to be in correspondence to the plurality of second magnetic poles 102b of the magnetic steel. In a same stator assembly 20, one respective first pole claw 2032 and one respective second pole claws 2042 have opposite magnetism, for example, one is configured as N pole and the other is configured as S pole. Furthermore, the plurality of first pole claws 2032 and the plurality of second pole claws 2042 are all arranged at equal intervals, and the width of each first pole claw 2032 and the width of each second pole claw 2042 gradually decrease along their respective extension directions.

In some embodiments, referring to FIGS. 3 and 4, a cylindrical film 205 is provided between the pole claw ring 20b and the respective coils 202.

The beneficial effects of the present disclosure are that the stepper motor according to the embodiments of the present disclosure includes: a rotor assembly including a rotatory shaft and a plurality of magnetic steel units sequentially assembled along circumference of the rotatory shaft, where inner walls of the plurality of magnetic steel units are in contact with an outer wall of the rotatory shaft, and the plurality of magnetic steel units are assembled to form a magnetic steel; a stator assembly sleeved on the rotor assembly, where the stator assembly includes a fixed claw pole arranged around circumference of the magnetic steel and coils sleeved on the fixed claw pole; and two support assemblies respectively arranged at both ends of the rotor assembly, where each support assembly of the two support assemblies includes a respective bearing sleeved on the rotatory shaft. The rotatory shaft includes a main body connected to the magnetic steel and two end portions respectively located at both ends of the main body, respective bearings are sleeved on the two end portions respectively, and a diameter of the main body is smaller than diameters of the two end portions. By assembling the plurality of magnetic steel units sequentially along circumference of the rotatory shaft and allowing the inner walls of the plurality of magnetic steel units to be in contact with the outer wall of the rotatory shaft, the structural strength of the rotatory shaft can be increased. Moreover, the rotatory shaft includes the main body connected to the magnetic steel and two end portions respectively cooperating with the respective bearings, and the diameters of the two end portions are larger than the diameter of the main body, in this way, the structural strength of the rotatory shaft can be further increased.

The above mentioned are only the embodiments of the present disclosure. It should be pointed out that for those skilled in the art, improvements can be made without departing from the inventive concept of the present disclosure, but these improvements are all within the scope of protection of the present disclosure.

What is claimed is:

1. A stepper motor, comprising:
a rotor assembly including a rotatory shaft and a plurality of magnetic steel units sequentially assembled along circumference of the rotatory shaft, wherein inner walls of the plurality of magnetic steel units are in contact with an outer wall of the rotatory shaft, and the plurality of magnetic steel units are assembled to form a magnetic steel;
at least one stator assembly sleeved on the rotor assembly, wherein each stator assembly of the at least one stator assembly includes a respective fixed claw pole arranged around circumference of the magnetic steel and respective coils sleeved on the respective fixed claw pole; and
two support assemblies respectively arranged at both ends of the rotor assembly, wherein each support assembly of the two support assemblies includes a respective bearing sleeved on the rotatory shaft;
wherein the rotatory shaft includes a main body connected to the magnetic steel and two end portions respectively located at both ends of the main body, respective bearings are sleeved on the two end portions respectively, and a diameter of the main body is smaller than diameters of the two end portions.

2. The stepper motor according to claim 1, wherein the respective bearing is a ball bearing or a sliding bearing.

3. The stepper motor according to claim 2, wherein each support assembly of the two support assemblies further includes a respective end cap connected to the rotatory shaft via the respective bearing, and the rotatory shaft is rotatable relative to the respective end cap.

4. The stepper motor according to claim 3, wherein gaskets are provided respectively at a top and a bottom of the magnetic steel, the gaskets are respectively sleeved on the two end portions, and a diameter of an outer periphery of a respective gasket of the gaskets is equal to a diameter of an outer periphery of the magnetic steel.

5. The stepper motor according to claim 2, wherein the respective bearing includes an inner ring connected to a corresponding end portion, an outer ring arranged to enclose an outer surface of the inner ring, and balls arranged between the inner ring and the outer ring, and wherein a first ball guide groove configured to cooperate with the balls is defined on the outer surface of the inner ring, a second ball guide groove configured to cooperate with the balls is defined on an inner surface of the outer ring, and the first ball guide groove and the second ball guide groove form an accommodating chamber for accommodating the balls.

6. The stepper motor according to claim 1, wherein each stator assembly of the at least one stator assembly further includes a respective housing sleeved on the respective coils; and
wherein the respective housing includes a plurality of housing walls sequentially connected to each other around circumference of the respective coils, the plurality of housing walls includes two first housing walls, outer walls of the first housing walls are planar and hollow portions for receiving the respective coils are formed on the first housing walls, portions of the respective coils are respectively received in the hollow portions, and the two first housing walls are arranged to face each other.

7. The stepper motor according to claim 6, wherein first planes parallel to the outer walls of the first housing walls are formed on the portions of the respective coils received in the hollow portions.

8. The stepper motor according to claim 6, wherein the respective housing includes four housing walls sequentially connected to each other around the circumference of the respective coils and further includes a second housing wall and a third housing wall arranged to face each other, and each of the second housing wall and the third housing wall has a respective curved outer wall;
wherein the third housing wall includes a plurality of wall sections sequentially connected to each other around the circumference of the respective coils, and each wall section of the plurality of wall sections has a respective planar outer wall; and
wherein the stepper motor further includes a circuit broad fixed to the third housing wall, and the circuit broad includes a plurality of circuit broad units respectively fixed to the plurality of wall sections.

9. The stepper motor according to claim 1, including a plurality of stator assemblies and a plurality of housings respectively sleeved on the plurality of stator assemblies, wherein the plurality of stator assemblies are stacked along an axial direction of the rotor assembly, and the plurality of housings are also stacked along the axial direction of the rotor assembly.

10. The stepper motor according to claim 1, wherein the respective fixed claw pole includes a first claw pole portion and a second claw pole portion arranged to face and cooperate with each other;
wherein the first claw pole portion includes a first base sleeved on the rotatory shaft and first pole claws bending and extending, along an axial direction of the rotatory shaft, from an edge of the first base towards the second claw pole portion, and the first pole claws are arranged at intervals along circumference of the first base;
wherein the second claw pole portion includes a second base sleeved on the rotatory shaft and second pole claws bending and extending, along the axial direction of the rotatory shaft, from an edge of the second base towards the first base, and the second pole claws are arranged at intervals along circumference of the second base; and
wherein the first pole claws are arranged to interleave with the second pole claws, each first pole claw of the first pole claws is located between two respective adjacent second pole claws of the second pole claws, the first pole claws and the second pole claws form a pole claw ring, and the respective coils are sleeved on circumference of the pole claw ring.
